(19) United States
(12) Patent Application Publication
(10) Pub. No.: US 2008/0078975 A1
(43) Pub. Date: Apr. 3, 2008

(54) Heat transport medium

(76) Inventors: Touru Kawaguchi, Kariya-city (JP); Eiichi Torigoe, Anjo-city (JP); Yoshimasa Hijikata, Nishikamo-gun (JP); Toshiyuki Morishita, Nagoya-city (JP); Yasumasa Hagiwara, Kariya-city (JP)

Correspondence Address: HARNESS, DICKEY & PIERCE, P.L.C., P.O. BOX 828, BLOOMFIELD HILLS, MI, 48303, US

(21) Appl. No.: 11/903,804

(22) Filed: Sep. 25, 2007

(30) Foreign Application Priority Data
Sep. 29, 2006 (JP) 2006-269090

(51) Int. Cl. C09K 5/10

(52) U.S. Cl. 252/71

(57) ABSTRACT

A heat transport medium includes a single solvent and fine particles 1 of a predetermined material dispersed in the solvent, and transports heat transferred from a heat transfer surface 5. Fine particles 1 includes one or more atoms, and structural substances 3 are arranged on a surface of fine particles 1 to protect it. Furthermore, structural substances 3 having a functional group capable of adsorbing onto fine particles 1 are floated around fine particles 1 in a state where structural substances are not adsorbed onto the fine particle. Also, structural substances 3 adsorbed onto the surface of fine particles 1 are arranged so as to form spaces which enable the floating structural substances 3 to adsorb around the fine particle.

### TECHNICAL FIELD

The present invention relates to a heat transport medium which transfers or transports heat.

### BACKGROUND ART

A heat transport medium, which transfers or transports heat from a heat source externally, has been conventionally used in a device which dissipates heat from a heat source, e.g., an engine, electronic equipment and the like mounted on a vehicle. The heat transport medium takes heat away from a heat source, and dissipates it via a heat exchanger. Moreover, the heat transport medium is also used for transferring heat to an object to be heated. It has been required of such a heat transport medium to have a higher cooling capability, i.e., a higher heat-transporting capability, in order to increase energy efficiency of equipment such as a heat exchanger or the like.

To improve the heat-transporting capability of a heat transport medium, for example, a technique has been known, in which solid particles of a material such as metal having high thermal conductivity are included and dispersed in the heat transport medium. By including the particles of a material having high thermal conductivity in a medium, the heat transport medium gets higher thermal conductivity than that of a medium which does not contain the particles. More particularly, it has been known that the thermal conductivity of a heat transport medium that include particles, changes based on the Maxwell formula of 1881, as follows:

Thermal conductivity of a medium including spherical particles increases according to the volume fraction of the particles.

Thermal conductivity of a medium including spherical particles increases according to the ratio of surface area to the volume of the particles.

### However, there is a limitation of improvement of thermal conductivity of a medium by this method.

On the other hand, a technique of making fine particles of a micron or nano size has been recently developed for particles included in the medium. It has been confirmed that thermal conductivity of a medium remarkably increases when fine particles are dispersed in the medium.

For example, Applied Physics Letters, Vol. 78, No. 6, pp. 718-720 (2001) states that thermal conductivity of a medium largely increases when a medium composed of ethylene glycol includes a small amount of fine particles of copper (Cu) having a diameter of 10 nm (nano meter) or less.

FIG. 5 in Applied Physics Letters, Vol. 78, No. 6, pp. 718-720 (2001) is a graph showing the relationship between a volume fraction ratio of particles in a medium and a thermal conductivity increasing ratio k/k₀ (thermal conductivity k of a medium after adding fine particles/thermal conductivity k₀ of a medium before adding fine particles), when various particles including copper particles are added to ethylene glycol.

As illustrated in FIG. 5, whenever a medium that includes particles composed of copper oxide (CuO), particles composed of alumina (Al₂O₃), which have a diameter of about 30 nm, and particles composed of copper having a diameter of about 10 nm or less, the thermal conductivity increasing ratio of the medium increases linearly according to the increased volume fraction ratio of the particles. More particularly, in the case of nano particles having a diameter of 10 nm or less, thermal conductivity is remarkably improved by adding a fewer amount of particles to a medium. Further, when an acid is added to Cu particles, particles are dispersed more stably in a medium, and thus higher thermal conductivity can be obtained. In addition, in FIG. 5, Cu (old) represents copper particles prepared two months before measurement, Cu (fresh) represents copper particles prepared two days before measurement, and Cu+Acid represents copper particles added to an acid so as to be stabilized as metal particles.

Like Applied Physics Letters, Vol. 78, No. 6, pp. 718-720 (2001), for example, Japanese Unexamined Patent Publication Nos. 2004-85108, 2004-501269 and 2004-339461 state that thermal conductivity and heat diffusivity of a medium increase when fine particles having high thermal conductivity are dispersed in a medium. More particularly, Japanese Unexamined Patent Publication No. 2004-501269 teaches that a slat of a carboxylic acid is adsorbed on the surface of fine metallic particle 2 so as to stabilize a colloidal solution of fine particles, and thus heat transport is carried out smoothly between the fine particles and medium. In addition, when a medium includes particles, it is desirable that the particles be dispersed more stably in the medium.

Japanese Unexamined Patent Publication Nos. 2002-532243 and 2002-532242 describe a technique to stably disperse particles in a medium, which is not a heat transport medium. For example, in the case of an ink jet printer, these patent documents propose a polymer having a hydrophilic group and the hydrophobic group being used as a dispersant when hydrophobic particles are dispersed in a medium such as water, or the like. In the techniques described in Japanese Unexamined Patent Publication Nos. 2002-532243 and 2002-532242, particles can be dispersed more stably in a medium by using a solvate obtained by compatibilizing a solvent to particle surfaces.

The above-described techniques for a heat transport medium increase thermal conductivity so as to improve a heat transport capacity of a medium. Thermal conductivity is an index expressing how heat is easily transferred inside a material (a medium in this case). Further, when a heat transport medium is used, the thermal conductivity, as well as the heat transfer rate which is an index expressing how heat is transferred from a heat transfer surface, which is a heat source, to a medium, or from the medium to a heat transfer surface are also important.

The relationship between the heat transfer rate α and thermal conductivity κ in a medium is represented by the following expression (1).

α ∝ κ^{2/3}·v^{(-1/6)}·ρ^{1/3}·Cp^{1/3} 1)

In this expression, v represents the kinematic viscosity of a medium, ρ represents the density of a medium, and Cp represents the specific heat of a medium. As can be understood from the expression (1), the heat transfer rate α is propositional to ⅔-power of the thermal conductivity κ, and is also propositional to ⅓-power of the specific heat Cp of a medium. The thermal conductivity of a heat transport medium can be remarkably improved by a conventional technique to disperse fine particles in the medium. However, there is a limitation in improvement of thermal conductivity, and therefore, it is difficult to further improve the thermal conductivity.

### SUMMARY OF INVENTION

Under these circumstances, the present invention has been conceived of and an object of the present invention is to provide a heat transport medium capable of accurately increasing a heat transfer coefficient while maintaining high thermal conductivity, and realizing heat transport with higher efficiency.

To achieve the above object, the present invention provides a heat transport medium, which transports heat which is transferred from a heat transfer surface. In the present invention, the heat transport medium comprises a solvent, and fine particles of a predetermined material, wherein the fine particles are dispersed in the solvent. Each fine particle consists of one or more atoms, and on a surface thereof, a plurality of first structural substances have been arranged. Each of the first structural substances has a functional group to be adsorbed onto the fine particle, and protects the fine particle. A plurality of second structural substances having a functional group capable of being adsorbed onto the fine particle are floated in the solvent, in a state where the second structural substances are not adsorbed to the fine particle.

According to the heat transport medium having the above-described constitution, as the heat transport medium has a structure where a structural change can arise around the fine particle, specific heat of the heat transport medium can be improved by actively causing the structural change. Thus, the thermal conductivity of the heat transport medium can be further improved.

In a preferable embodiment of the heat transport medium of the present invention, each of the first and second structural substances has a functional group with properties capable of adsorbing onto a metal. When a metal is contained in, or adhered to the fine particle, the fine particle can have a property capable of easily being adsorbed onto the structural substance which is floating in the solvent. Therefore, heat generation due to adsorption of the structural substances onto the fine particle easily occurs, and the specific heat of the heat transport medium can be further improved.

In another preferable embodiment of the heat transport medium of the present invention, as the first and second structural substances, a structural substance having a functional group which is capable of being adsorbed onto an inorganic material can be employed, a structural substance having a functional group with properties capable of being adsorbed onto an oxide can be employed, or a structural substances having a functional group with properties capable of being adsorbed onto an organic material can be employed. In any of these cases, it is possible to impart a property capable of easily being adsorbed onto the fine particle to the structural substance which is floating in the solvent. Thus, heat generation due to adsorption of the structural substances to the fine particles easily occurs, and the specific heat of the heat transport medium can be further improved.

In addition, in another preferable embodiment of the heat transport medium of the present invention, each of the first and second structural substances has a functional group with hydrophilicity. In this case, it is possible to impart affinity with a solvent to the first and second structural substances which are adsorbed onto the fine particle. Thus, heat absorption due to separation of the structural substances from the fine particle easily occurs, and the specific heat of the heat transport medium can be further improved.

Further, in another preferable embodiment of the heat transport medium of the present invention, each of the first and second structural substances has a functional group with lipophilicity. In this case, when the solvent contains oil or fat, it is possible to impart a property capable of easily dissolving in a solvent to the first structural substances adsorbed onto the fine particle. Thus, heat absorption due to separation of the structural substances easily occurs, and the specific heat of the heat transport medium can be further improved.

In another preferable embodiment of the heat transport medium of the present invention, each of the first structural substances comprises two or more kinds of materials, and thereby a bonding force between the first structural substance and the fine particle varies depending on the kind thereof. In this case, the structural substances having a small bonding force easily contribute to a structural change in the circumference of the fine particle. Thus, the specific heat of the heat transport medium can be increased.

Further, in another preferable embodiment of the heat transport medium of the present invention, the first structural substances are arranged so as to form spaces which enable the floating second structural substances to adsorb onto the fine particle. In this case, it is possible to form a structure at the surface of the fine particle so that the second structural substance can easily adsorb to the fine particle. Thereby, the structural substances can easily adsorb onto the fine particle, and the specific heat of the heat transport medium can be improved by an exothermic reaction.

In another preferable embodiment of the heat transport medium of the present invention, the second structural substances can contain another kind of structural substance different from the first structural substance, or in other words, a part of the second structural substance is different from the structural substances of the first structural substance. Further, in another preferable embodiment, the second structural substance can be constituted with the same kind of structural substance as the first structural substance.

In addition, in another preferable embodiment of the heat transport medium of the present invention, each of the fine particles has a core material which constitutes a core, and a surface material which exists on the surface of the core and is different from the core material.

Further, in another preferable embodiment of the heat transport medium of the present invention, the solvent consists of a single component, or the solvent consists of two or more kinds of components.

In addition, in another preferable embodiment of the heat transport medium of the present invention, thermal conductivity of each of the fine particles is greater than thermal conductivity of the solvent. In other words, fine particles having greater thermal conductivity than that of the solvent are used. In this case, the fine particles having greater thermal conductivity than that of the solvent are dispersed in the solvent, and thus the thermal conductivity of the heat transport medium is improved.

Further, in another preferable embodiment of the heat transport medium of the present invention, the average particle diameter of the fine particles is 5 nm (nanometer) or less. In this case, the surface area of the particles to be dispersed in the solvent remarkably increases, and many solvent molecules can be moved into the space between the structural substances arranged on the surface of the fine particle, or on the surface thereof. Thus, further improvement of a heat transporting ability of the heat transport medium can be expected.

In other preferable embodiments of the heat transport medium of the present invention, any one of the following constitutions can be employed:

a constitution in which each of the fine particles consists of a metal,

a constitution in which each of the fine particles consists of an inorganic material,

a constitution in which each of the fine particles consists of an oxide, and

a constitution in which each of the fine particles consists of an organic material.

On the other hand, in another preferable embodiment of the heat transport medium of the present invention, each of the fine particles consists of gold, the solvent consists of water, and each of the first and second structural substances has a hydrophilic group. In this case, for example, mercapt succinic acid and the like can be used as a structural substance.

In another preferable embodiment, each of the fine particles consists of gold, the solvent consists of toluene, and each of the first and second structural substances has a hydrophobic group. In this case, for example, n-octadecanethiol or the like can be used as a structural substance.

In another preferable embodiment of the heat transport medium of the present invention, the heat transport medium further contains one or more kinds of freezing-point depressants, which is effective to make the heat transport medium useful as an anti-freezing liquid.

In a further more preferable embodiment of the heat transport medium of the present invention, as a freezing-point depressant, a solid freezing-point depressant such as potassium acetate or the like, or a liquid freezing-point depressant such as ethylene glycol or the like can be used. When a heat transport medium has any these constitutions, the heat transport medium can be easily used especially in a cold environment, since the freezing point of cooling water and the like, used in a radiator mounted a vehicle is lowered.

Further, in another preferable embodiment of the heat transport medium of the present invention, the transport medium may further include at least any one of a rust preventing agent and an anti-oxidant as an additive.

### BRIEF DESCRIPTION OF THE DRAWINGS

FIG. 1 shows a drawing schematically illustrating the structured state of the first embodiment of a heat transport medium of the present invention.

FIG. 2 shows a drawing schematically illustrating the disassembled state of the heat transport medium.

FIG. 3 shows an enlarged view of FIG. 1.

FIG. 4 shows a drawing schematically illustrating an example of a structure of a fine particle and two or more kinds of structural substances being adsorbed onto the surface of the fine particle.

FIG. 5 shows a drawing schematically illustrating a fine particle, onto a surface of which a metal is adhered.

FIG. 6 shows a drawing schematically illustrating spaces between structural substances adsorbed to the surface of the fine particle.

FIG. 7 shows a drawing schematically illustrating an example of a structure where structural substances are adsorbed onto the surface of the fine particle, and various kinds of structural substances are floating in a solvent.

FIG. 8 shows a graph illustrating the relationship between a volume fraction of fine particles and a thermal conductivity ratio of a heat transport medium in an example of a conventional heat transport medium.

### DETAILED DESCRIPTION

A heat transport medium comprises a solvent and fine particles. Further, the heat transport medium can further include components which provide additional functions, e.g., depression of a solidifying point or a freezing point, rust prevention, and the like.

Furthermore, a plurality of first structural substances capable of protecting the fine particles are adsorbed onto the surface of the fine particles, and arranged there to form a protective film. The heat transport medium further comprises a plurality of second structural substances which are dispersed in the solvent around the fine particles on which the protective film has been formed. When the second structural substances are adsorbed onto the surface of the fine particle, an exothermic reaction occurs. On the contrary, when the adsorbed first and second structural substances are separated from the fine particles, an endothermic reaction occurs. As described above, a structural change in the circumference of the fine particles, such as desorption of the first and second structural substances, is reversible and is caused by a trigger such as a change in flow of a liquid, vibration or a change in temperature. Thus, the specific heat of the heat transport medium is improved by heat generated via the structural change. Fine particles in the state where the first and second structural substances are adsorbed onto the surface of the fine particles are referred to as structured particles.

A solvent is an aggregate of solvent molecules, and includes at least a component capable of having two states, in other words, a structured state (structured area) in which a solvent molecule is systematically structured and a disassembled state in which the structured state is disassembled. In addition, the changes between the structured state and the disassembled state are reversible, and the changes can be caused by a physically external trigger, such as a change in temperature or the like. When the structured state changes to the disassembled state, a heat transport medium absorbs heat. When the disassembled state changes to the structured state, a heat transport medium dissipates heat. Therefore, the combination of the component of a solvent and the component of fine particles is selected so as to form the structured state and the disassembled state around the fine particles. The component of a liquid (a solvent), the component of fine particles, and the exterior trigger are selected according to the application of a heat transport medium.

In a typical embodiment, a solvent is a carrier for dispersing the fine particles, first and second structural substances, and structured particles. The fine particles, first and second structural substances, and structured particles are generically referred to as particle components. The solvent can disperse the particle components, and can form a fluid to be transported. The fluid can be provided in a liquid state or a vapor state, and may be composed of a single component or a plurality of components. For example, water can be used as the fluid. For example, a liquid polymer can be used as the fluid. Further, a mixture can be used as the fluid. For example, a mixture of water, ethylene glycol and another functional component can be used.

### EXAMPLES

### First Embodiment

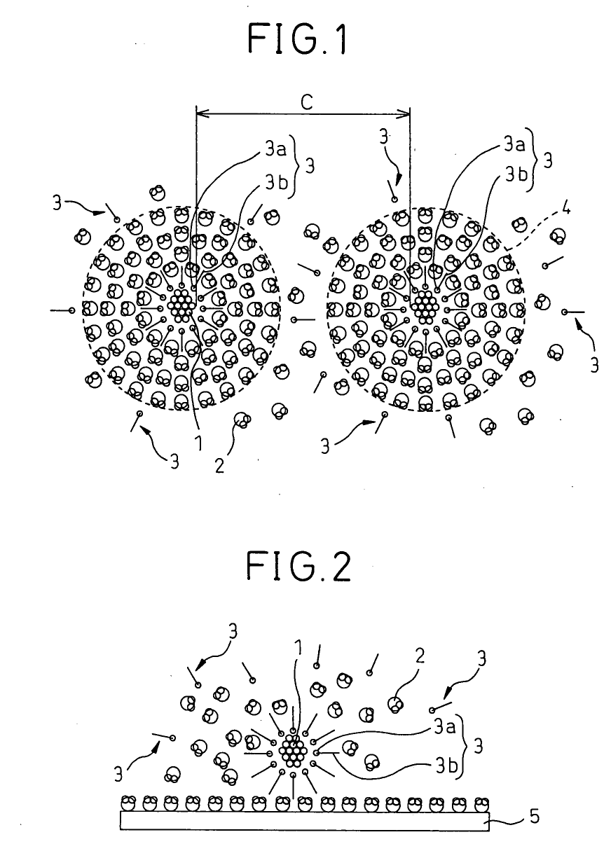

The first Embodiment of a heat transport medium according to the present invention will be described in detail below with reference to FIGS. 1 and 2.

For example, a heat transport medium according to this Embodiment is used to cool an engine, a transmission or the like mounted on a vehicle. The heat transport medium transfers or transports heat from a heat source externally. For example, a solvent used in the heat transport medium comprises a single component such as water or the like, and fine particles having higher thermal conductivity than that of the solvent.

The heat transport medium of this Embodiment transfers heat through a structural change, for example, adsorption of the structural substances floating in the medium onto the fine particles, and separation of the adsorbed structural substances. The heat transport medium also transfers heat, by having two different states, which are a structured state formed in a manner where a solvent is surrounding each of the fine particles, and a disassembled state in which the structured state is disassembled. FIGS. 1 and 2 schematically illustrate the above-described two states in the heat transport medium.

As illustrated in FIG. 1, in a heat transport medium, each of a plurality of fine particles 1 is surrounded by solvent molecules 2 of water in the state where a plurality of structural substances 3 adheres onto fine particle 1, and is dispersed. As fine particles 1, for example, a particle consisting of a metal such as gold (Au), silver (Ag), copper (Cu), iron (Fe), nickel (Ni) or the like, or an inorganic material such as silicon (Si), fluorine (F) or the like, a particle consisting of an oxide such as alumina (Al₂O₃), magnesium oxide (MgO), copper oxide (CuO), diiron trioxide (Fe₂O₃), titanium oxide (TiO) or the like, or a polymer particle consisting of an organic material such as a resin or the like can be used. Also, the fine particles 1 can be composed of two or more kinds of materials selected from metals, inorganic materials, oxides and polymer particles made of a resin, as listed above.

Structural substances 3 protecting fine particles 1 are regularly arranged on a surface of fine particles 1 which are dispersed in the heat transport medium so as to form a protection film. The structural substances 3 adhered to and arranged on the surface of the fine particle 1 correspond to the first structural substances in the present invention. The structural substance 3 includes a functional group 3a to be adsorbed onto the surface of fine particle 1, and a functional group 3b having a shape extending from the functional group 3a and having high affinity for the solvent molecule 2. Further, structural substance 3 includes an organic material having a linear chain as a main chain thereof.

This structural substance 3 has preferably a functional group having a property capable of adsorbing to a metal or an oxide. A structural substance can be employed, which has one or more functional groups selected from, for example, a thiol group (SH group), an amino group (NH₂ group) and a carboxyl group (COOH group) As a result, it is promoted that a state of structural substances 3 changes into an adsorbed state from a floating state. The structural substances 3 in the floating state correspond to the second structural substances in the present invention.

This structural substance 3 preferably has a functional group having a property capable of adsorbing to an inorganic material, and a structural substance having, for example, a thiol group (SH group) can be employed. As a result, it is promoted that structural substances 3 change into an adsorbed state from a floating state.

Also, this structural substance 3 preferably has a functional group with hydrophilicity, and a structural substance having one or more functional groups selected from, for example, an amino group (NH₂ group), a carboxyl group (COOH group), a hydroxyl group (OH group) and a sulfo group (SO₃H group) can be employed. As a result, the functional groups have affinity for the solvent molecule, and the separated state of structural substances 3 can easily occur.

In addition, this structural substance 3 preferably has a functional group with lipophiliicty, and a structural substance having, for example, a methyl group (CH₃ group) can be employed. As a result, the structural substance 3 is easily dissolved in oil or fat, and thus the separated state of structural substances 3 can easily occur.

For example, when gold is used as the fine particle 1, a thiol group (SH group), an amino group (NH₂ group) or a carboxyl group (COOH group) can be used as functional group 3a for adsorbing to the fine particle 1. As functional group 3b having high affinity for the solvent molecule 2 of water, for example, a hydrophilic group such as a carboxylic group (COOH group), an amino group (NH₂ group), a hydroxyl group (OH group), or a sulfo group (SO₃H group) can be used. More particularly, mercaptosuccinic acid (C₄H₆O₄S) which includes a thiol group as the functional group 3a, and a hydroxyl group as the functional group 3b can be used as the structural substance 3.

Thus, the structural substances 3 are adsorbed to and arranged on the surface of the fine particle 1, and thereby a protective film is formed on the fine particle 1. Further, solvent molecules 2 are moved into the spaces between structural substances 3, and are also taken onto the surface of structural substances 3 so as to form a structured area 4 where solvent molecules 2 are aggregated around the fine particle 1. Then, each fine particle 1 is stably dispersed in a heat transport medium.

A plurality of structural substances 3 are floating around the structured area 4, and structural substances 3 are seeking an opportunity to change the structure around fine particles 1 from the floating state, where structural substances 3 are separated from the fine particles, to the adsorbed state, by a trigger such as a change in flow of a liquid, vibration or a change in temperature. Herein, the floating state and adsorbed state of structural substances 3 reversibly change along with the absorption of heat from the exterior to the solvent, or dissipation of heat from the solvent to the exterior. A change from the adsorbed state to the floating state is an endothermic reaction, while a change from the floating state to the adsorbed state is an exothermic reaction. Latent heat is generated in a change between these two states. Thus, the specific heat of the heat transport medium can be improved by the latent heat, and an amount of heat to be transported can largely increase through these changes of state.

In order to create a heat transport medium containing structural substances in the floating state, and structural substances in the adsorbed state, the following method is carried out. For example, a two-phase reduction method can be used. According to this method, the structural substances which will become a protective film are mixed with a solution containing metal ions, and the fine particles on which the protective film is formed are made by utilizing the reduction method. Then, these fine particles are mixed with toluene which is a solvent, and thereby the fine particles are dispersed in the toluene. Furthermore, the structural substances to be floated in the medium are mixed in a toluene solution of the fine particles. The order of introducing toluene and the structural substances to be floated may be varied. In other words, it is necessary to first form a stable protective film on fine particles 1, by carrying out the step of adsorbing the structural substances to fine particles 1 which becomes a core.

The structured area 4 becomes disassembled as illustrated in FIG. 2, due to various factors such as mutual clashing of fine particles 1, clashing of fine particles 1 to the wall surface of a heat exchanger or the like where a heat transport medium flows, vibrating or shaking of structural substances 3 depending on a change in temperature of a heat transport medium, and the like. In the disassembled state, solvent molecules 2 are separated from the spaces between structural substances 3 or the surfaces of structural substances 3, and irregularly exist in the solvent. Further, a part of the separated solvent molecules 2 are adsorbed to a heat transfer surface 5 to which heat is transferred from the heat transport medium.

The two different states illustrated in FIGS. 1 and 2 reversibly change along with absorption of heat from the exterior to a solvent, and dissipation of heat from the solvent to the exterior. The change from the structured state to the disassembled state is an endothermic reaction, while the change from the disassembled state to the structured state is an exothermic reaction. Thus, when these state changes occur, latent heat is generated. The latent heat represents an energy difference between two states at a certain constant temperature. For example, in the case of water, the latent heat generated due to the structural change from solid (ice) to liquid is about 6,000 J/mol (joule/mol). This value is remarkably greater than 75 J/mol, which is the value of molar specific heat (sensible heat) of water. Further, the inventors have confirmed that latent heat (energy difference) between the structured state and the disassembled state according to this Embodiment is also great. Thus, an amount of heat to be transported can greatly increase through the state change.

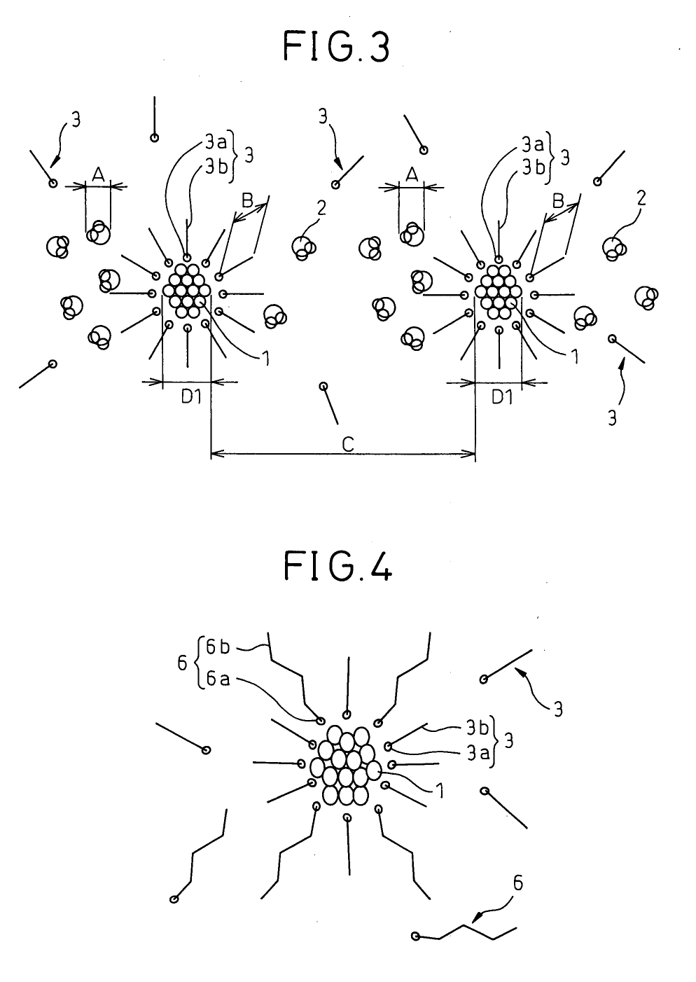

FIG. 3 is a simplified enlarged schematic view of FIG. 1. The structural change of fine particles 1 and structural substances 3 in the heat transport medium, and the more concrete structure in the structured state will be described later in detail. In this Embodiment, a solvent molecule 2 is water, fine particle 1 is gold, and a structural substance 3 is mercaptosuccinic acid.

As illustrated in FIG. 3, a diameter A of each of solvent molecules 2 is about 0.1 nm. For example, when structural substances 3 adsorbed and arranged on the surface of fine particle 1 are mercaptosuccinic acid, a length B of each of structural substances 3 extending from a functional group 3a to be adsorbed to fine particle 1 is about 1 nm. In other words, the length B of the structural substance 3 is equal to or larger than diameter A of the solvent molecule, and the expression of A≦B is satisfied. Further, the length B of the structural substance 3 is half or less than the average space distance C between the dispersed fine particles, and the expression B≦C/2 is satisfied.

A plurality of fine particles 1 with a protective film (structural substances 3) exist in the heat transport medium in the dispersed state as satisfying this expression, and solvent molecules 2, which are intended to form a structured state, and structural substances 3, which are intended to adsorb to the fine particle 1, exist around each fine particle 1 in the dispersed state.

If the expression A≦B is satisfied, solvent molecules 2 can be easily moved into the space between the structural substances 3, and on the surface of structural substances 3, and thus the solvent molecules 2 are easily adsorbed onto the surface of fine particles 1 so as to form the above-described structured area 4 (refer to FIG. 1). If the expression B≦C/2 is satisfied, the structural substances 3 can be easily deformed, in other words, shaken or vibrated, and thus solvent molecules 2 are easily separated from the surface of fine particles 1 to disassemble structured area 4.

By constituting a heat transport medium satisfying the expressions A≦B and B≦C/2 is formed, adsorbing and separating the solvent molecules to or from the fine particle 1 can be properly controlled, and thus an amount of heat to be transported can largely increase. In addition, such a heat transport medium can be obtained by adjusting a size of the solvent molecule, the length B of structural substances 3 included in the heat transport medium, and an amount of fine particles 1 included in the heat transport medium.

The diameter A of the solvent molecule is measured by specifying a component by a liquid chromatograph mass spectrometer or the like. The length B of the structural substance is measured specifying a component and structural substances by a gas chromatograph mass spectrometer, a Fourier transform mass spectrometer, a nuclear magnetic resonance spectrometer, or the like. The average clearance distance C is calculated specifying the weight ratio of particles measured by a thermogravimetric device, an average particle diameter measured by a transmission electron microscope or a particle size distribution measuring device, and a component measured by a characteristic X-ray analyzer or an electronic spectrometer.

More particularly, for example, the fine particles 1 are an aggregate of 150 gold (Au) atoms, and an average diameter D of one particle is about 1.8 nm. When fine particles 1 have the average particle diameter of 2 nm or less, where the average particle diameter D is experimentally about 5 nm or less at the maximum, the surface area of each of fine particles 1 dispersed in a heat transport medium can greatly increase, and thus a greater amount of solvent molecules 2 can form the structured area 4.

As described above, based on a heat transport medium according to this Embodiment, the following advantageous effects can be obtained.

(1) A fine particle 1 comprises about 150 gold (Au) atoms, structural substances 3 to protect the fine particle 1 are adsorbed and arranged on the surface of the fine particle 1 to form a protective film, and structural substances 3 as a reserve for forming the protective film are dispersed in the floated state around the fine particle. As a result, a structural change around the fine particle 1 is actively caused to improve the specific heat of the heat transport medium.

(2) Furthermore, the length B of the structural substance 3 is equal to or larger than the diameter A of the solvent molecule 2. Taking this constitution, solvent molecules 2 can be easily moved into the spaces between structural substances 3 arranged on the surface of fine particle 1, and onto the surface of structural substances 3, so that solvent molecules 2 are adsorbed around the fine particle so as to form the structured area 4.

The structural substance 3 can be easily deformed by vibration and shaking. Thus, solvent molecules 2 can be easily separated from the surface of fine particle 1, and, in other words, the structured area 4 can be easily disassembled. When the structural change (adsorption and desorption) of structural substances 3 around the fine particle 1 arises, and the structured area 4 is formed and disassembled, the exothermic and endothermic reactions are respectively generated between the solvent molecules 2 and fine particle 1 and between the solvent molecules 2 and structural substances 3 due to changing these structural substances. Therefore, since an amount of heat corresponding to latent heat is transferred from the heat transfer surface to the heat transport medium, the heat transfer rate of a heat transport medium can be improved, and thus the heat transport capacity of the medium can increase.

(3) As fine particles 1, a material having higher thermal conductivity than the thermal conductivity of a solvent is used. Accordingly, since fine particles 1 having higher thermal conductivity than that of the solvent are dispersed in a heat transport medium, the thermal conductivity of the heat transport medium can be accurately improved.

(4) The structural substance 3 comprises a linear chain organic material to be regularly arranged on the surface of fine particle 1. Accordingly, structuring fine particles 1 and solvent molecules 2 can be promoted.

(5) Fine particles 1 have a particle diameter D1 of 5 nm or less at the maximum. Accordingly, the surface area of each of fine particles 1 dispersed in a heat transport medium can greatly increase, and a greater amount of solvent molecules 2 can form structured area 4. Therefore, the heat transport capacity of the heat transport medium can be further improved.

In addition, the heat transport medium according to the first Embodiment can be modified as follows:

### Modified Example 1

The structural substances to be adsorbed onto the surface of fine particle 1 may have the following constitution. As shown in FIG. 4, the structural substances arranged on the surface of fine particles 1 may further include structural substances 6 having a functional group 6a and a functional group 6b having a meandering or zigzag shape extending from the functional group 6a, in addition to structural substances 3 having the functional group 3a to be adsorbed onto the surface of fine particle 1, and the functional group 3b having a shape extending from the functional group 3a. Also, structural substances 3, 6 which are floating around fine particles 1 (corresponding to the second structural substances) may be the same as structural substances 3, 6 which are adsorbed onto the surface of fine particles 1 (corresponding to the first structural substances).

### Modified Example 2

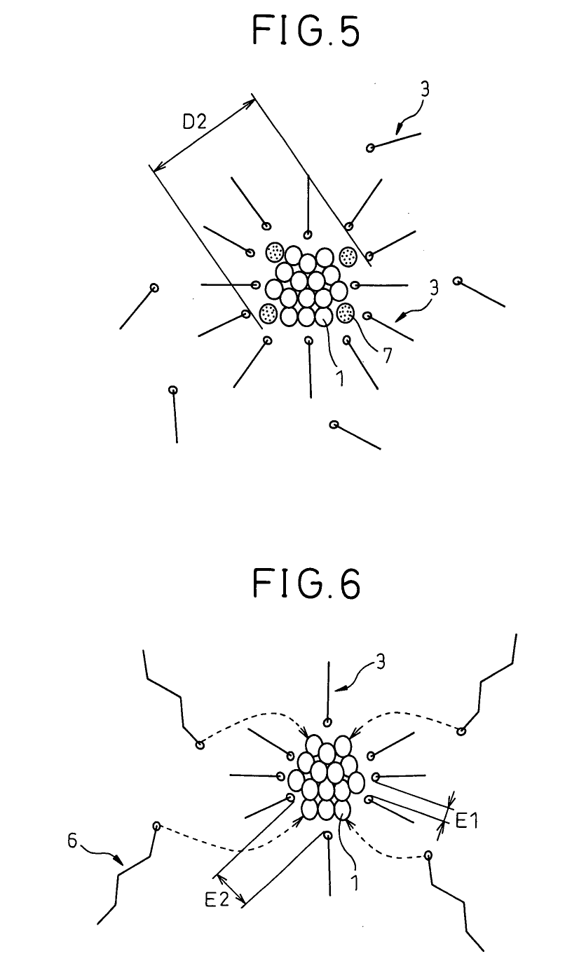

Fine particles 1 composed of an aggregate of one or more atoms may have the following constitution. In other words, as shown in FIG. 5, the fine particle 1 can be composed of a core material constituting a core, and a surface material constituting an outer layer for covering the core material. The surface material may be a metal 7. An average particle diameter D2 of the particles including metal 7 is preferably 5 nm or less. By such a constitution, the same operation and effect as that described in above paragraph (5) are exerted. Furthermore, by utilizing metal 7's property which is capable of adsorbing structural substances, adsorption and desorption (structural changes) of structural substances to or from fine particle 1 can be controlled. As for the metal 7, for example, gold (Au), silver (Ag), copper (Cu) and nickel (Ni) can be used.

The following method is carried out so as to create this constitution. For example, before forming fine particles 1 covered with a protective film, a liquid containing metal 7 is mixed with, e.g. gold particles as the core material. As a result, metal 7 adheres to the gold particles through the liquid, and thus multi-layered fine particles 1 capable of adsorbing the structural substances can be formed.

Structural substances 3 forming the protective film adsorbs not only onto the surface of the core material, but also onto the surface or the boundary portion between the metal 7 and core material. In the place of metal 7, a metal oxide can also be employed. In this case, alumina (Al₂O₃), magnesium oxide (MgO), copper oxide (CuO), diiron trioxide (Fe₂O₃), titanium oxide (TiO) or the like can be used as the metal oxide. Furthermore, various materials listed as the material of fine particle 1 can be used as the core material and the surface material.

### Modified Example 3

Structural substances 3 arranged on the surface of fine particle 1 may have the following constitution. Structural substances 3 may be arranged on the surface of fine particles 1 in a state that structural substances 3 formed the spaces where the structural substances floating around fine particles 1 can adsorb. As shown in FIG. 6, the distances between structural substances 3 (corresponding to the first structural substances) arranged on the surface of the fine particles (a distance between functional groups 3a) are represented as a space dimension E1, a space dimension E2 and the like, and E1 and E2 are adjusted so that they larger than the dimensions of the functional groups 3a, 6a of structural substances 3, 6 floating around fine particles 1. By such a constitution, the floating structural substances 3, 6 (corresponding to the second structural substances) are easily adsorbed onto the surface of fine particles 1 with space dimensions E1 and E2, and thus structural changes around the fine particles are promoted.

In order to create this constitution, the following method is carried out. For example, when fine particles 1 with a protective film is formed, when mixing structural substances 3 which form the protective film with fine particles 1 by stirring is decreased. As a result, the time of the reaction between structural substances 3 and fine particles 1 is reduced, and thereby the amount of structural substances 3 to be adhered to fine particles 1 is reduced. Thus, space dimensions E1 and E2 described above can be formed.

### Modified Example 4

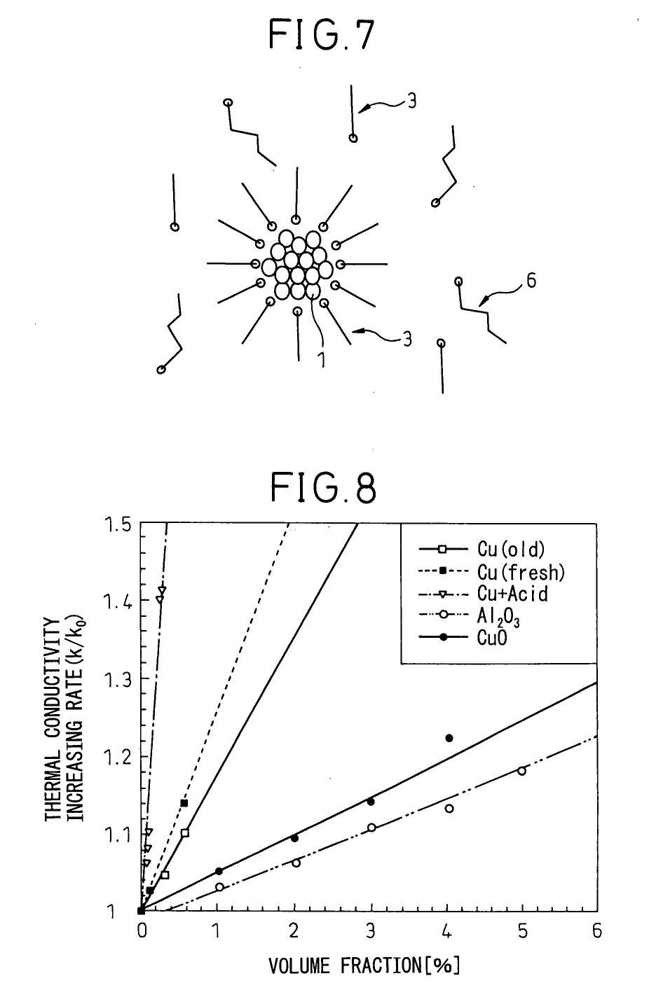

As shown in FIG. 7, the structural substances floating around the fine particle 1 (corresponding to the second structural substances) may include structural substances 6 which are different kinds of structural substances from the structural substances adsorbed onto the surface of fine particles 1 (corresponding to the first structural substances).

### Modified Example 5

In the first Embodiment described above, gold (Au) is used as the fine particles 1 to be used for a heat transport medium, water is used as the solvent, and structural substances 3 arranged on the surface of fine particles 1, each of which has a hydrophilic functional group (a hydrophilic group) 3b, are employed. However, an organic solvent can be used as the solvent, in place of water. More particularly, toluene, hexane, diethyl ether, chloroform, ethyl acetate, tetrahydrofuran, methylene chloride, acetone, acetonitrile, N,N-dimethyl formamide, dimethyl sulfoxide, butanol acetate, 2-propanol, 1-propanol, ethanol, methanol, formic acid, and the like can be used.

In this case, as for structural substances 3, a structural substance can be used, which has a group (functional group) 3a for adsorbing to the surface of the fine particle 1, and a hydrophobic group such as an alkyl group (CₙH₂ₙ₊₁) or the like. The alkyl group has high affinity for solvent molecules 2 of an organic solvent. Accordingly, solvent molecules 2 are moved into the spaces between structural substances 3, and onto the surface of structural substances 3 so as to form the structured area 4. More particularly, for example, when the solvent is toluene, the diameter A of solvent molecules 2 is about 0.6 nm. For example, when octadecanethiol (C₁₈H₃₇SH) is used as structural substances 3 arranged on the surface of fine particles 1, the length B of the structural substance 3 from the functional group 3a adsorbed to the fine particle 1 is about 2.5 nm. In other words, in this Modified example, the diameter B of structural substance 3 is equal to or larger than the diameter A of each of solvent molecules 2, and thus the expression A≦B is satisfied. Further, the expression B≦C/2 is also satisfied in this heat transport medium.

### Second Embodiment

A heat transport medium according to the second embodiment will be described. The heat transport medium according to this embodiment has a similar basic structure to that of above-described embodiments. However, a solvent consists of two more kinds of components in this embodiment unlike the first embodiment. In other words, in this embodiment, water and ethylene glycol are used as a solvent.

The ethylene glycol is a liquid freezing-point depressant agent having the effect to depress a freezing point and can depress the freezing point of a solvent to about −20 degree C. In other words, a solvent including ethylene glycol is more practical for use in a cold environment and the like. Further, in this Embodiment, gold (Au) is also used as fine particles 1, and mercaptosuccinic acid can be used as structural substances 3. The heat transport medium according to this Embodiment satisfies the expression A≦B between length B of the structural substance 3 and diameter A of the solvent molecule 2 having the maximum diameter among two or more kinds of the solvents, and also satisfies the expression B≦C/2 between length B of structural substance 3 and the average space dimension C between fine particles 1. In addition, for example, propylene glycol, and etc. other than ethylene glycol, can be used as the freezing-point depressant in addition to ethylene glycol.

Accordingly, since any of the above-described solvent molecules 2 are easily moved into the space between structural substances 3 arranged on the surface of fine particle 1, and on the surface of structural substances 3, solvent molecules 2 are adsorbed to the surface of fine particle 1 so as to form the structured area 4 (refer to FIG. 1). Further, structural substances 3 can be easily deformed, in other words, by shaking or vibrating, adsorbed solvent molecules 2 are separated from the surface of fine particle 1 so as to easily disassemble the structured area 4. Therefore, adsorbing/separating solvent molecules 2 to/from fine particle 1 can be properly controlled, and thus an amount of transported heat can largely increase.

As described above, the heat transport medium according to the second Embodiment can obtain similar or corresponding effects to those of the above-described (1) to (5) in the first Embodiment.

In addition, in the heat transport medium according to the second Embodiment, the kind of a solvent, structural substances 3, or constitution of the structural substances 3 can be varied, corresponding to each supplemented modified example of the first Embodiment.

The second Embodiment uses two kinds of components as a solvent, and one of the components is a liquid having the effect to depress a freezing point. The solvent may consist of one kind of component, and a solid freezing-point depressant can be contained in this solvent. For example, water may be used as a solvent, and potassium acetate, sodium acetate, or the like can be used as a freezing-point depressant.

Further, a solvent may consist of two or more kinds of components, and a solid freezing-point depressant can be included as one of components. In this case, the freezing point of a heat transport medium can be depressed, and thus practical use of the medium in a cold environment can be increased. Further, a heat transport medium can include a rust preventing agent and an antioxidant as an additive, if necessary, in addition to a freezing-point depressant. In addition, if it is not necessary to depress the freezing point of a heat transport medium, two or more kinds of solvents not including a freezing-point depressant may be used for the heat transport medium.

### Another Embodiment

The variable factors commonly applied to the above embodiments and modified examples are as follows:

In each embodiment and modified example described above, fine particles 1 having an average particle diameter D1 of about 1.8 nm were employed. However, if the average diameter D1 of fine particles 1 is about 5 nm or less at the maximum, the effect of increasing the surface area of each of the fine particles dispersed in a solvent can be sufficiently obtained. In addition, when the thermal conductivity and heat transfer rate are sufficiently improved by forming and disassembling structured areas 4 by structural substances 3 arranged on the fine particle 1, and solvent molecules 2, fine particles having the average diameter D1 of more than 5 nm can be used as fine particles 1.

Further, in each embodiment and each modified example, a material having higher thermal conductivity than that of a solvent was used as fine particles 1. However, when the thermal conductivity and heat transfer rate are sufficiently improved by forming and disassembling structured areas 4 by structural substances 3 arranged on the fine particle 1, and solvent molecules 2, the relationship between the fine particles and a solvent is not necessarily restricted in the above-described relationship.

In addition, although it is described in the above embodiments that a solvent included in a heat transport medium consists of one or two kinds of components, a solvent can be composed of three or more kinds of components. The components in this case include water, ethylene glycol, and an organic solvent (an organic material) described in Modified example 5.

In addition, it is described in the above embodiments that each of the structural substances arranged on the surface of fine particle 1, or the structural substances floating around fine particles 1 consists of one or more kinds of materials, but it can be composed of three or more kinds of materials. As for the three kinds of materials, for example, it is possible to use a material having one or more functional groups selected from a thiol group (SH group), a carboxyl group (COOH group), an amino group (NH₂ group), a hydroxyl group (OH group), a sulfo group (SO₃H group) and a methyl group (CH₃ group).

We claim:

1. A heat transport medium for transporting heat transferred from a heat transfer surface, comprising a solvent and fine particles of a predetermined material, which have been dispersed in the solvent, wherein
each fine particle consists of one or more atoms,
a plurality of first structural substances, which have a functional group to be adsorbed onto the fine particle and protect the fine particle, are arranged on a surface the fine particle, and
a plurality of second structural substances, which have a functional group capable of being adsorbed onto the fine particle, are floated in the solvent in the state of not being adsorbed onto the fine particle.

2. The heat transport medium according to claim 1, wherein each of the first and second structural substances has a functional group with properties capable of adsorbing onto a metal.

3. The heat transport medium according to claim 1, wherein each of the first and second structural substances has a functional group with properties capable of adsorbing onto an inorganic material.

4. The heat transport medium according to claim 1, wherein each of the first and second structural substances has a functional group with properties capable of adsorbing onto an oxide.

5. The heat transport medium according to claim 1, wherein each of the first and second structural substances has a functional group with properties capable of adsorbing onto an organic material.

6. The heat transport medium according to claim 1, wherein each of the first and second structural substances has a functional group with hydrophilicity.

7. The heat transport medium according to claim 1, wherein each of the first and second structural substances has a functional group with lipophilicity.

8. The heat transport medium according to claim 1, wherein each of the first structural substances comprises two or more kinds of materials.

9. The heat transport medium according to claim 1, wherein the first structural substances are arranged so as to form spaces which enable the second structural substances to adsorb onto the fine particle.

10. The heat transport medium according to claim 1, wherein a part of the second structural substances are different kind of structural substances from the kind of the first structural substances.

11. The heat transport medium according to claim 1, wherein the second structural substances are the same kind of structural substances as the kind of the first structural substances.

12. The heat transport medium according to claim 1, wherein each of the fine particles has a core material which constitutes a core, and a surface material which exists on the surface of the core and is different from the core material.

13. The heat transport medium according to claim 1, wherein the solvent consists of a single component.

14. The heat transport medium according to claim 1, wherein the solvent consists of two or more kinds of components.

15. The heat transport medium according to claim 1, wherein thermal conductivity of each of the fine particles is greater than thermal conductivity of the solvent.

16. The heat transport medium according to claim 1, wherein the average particle diameter of the fine particles is 5 nm (nanometer) or less.

17. The heat transport medium according to claim 1, wherein each of the fine particles consists of a metal.

18. The heat transport medium according to claim 1, wherein each of the fine particles consists of an inorganic.

19. The heat transport medium according to claim 1, wherein each of the fine particles consists of an oxide.

20. The heat transport medium according to claim 1, wherein each of the fine particles consists of an organic material.

21. The heat transport medium according to claim 17, wherein each of the fine particles consists of gold, the solvent consists of water, and each of the first and second structural substances has a hydrophilic group.

22. The heat transport medium according to claim 17, wherein each of the fine particles consists of gold, the solvent consists of toluene, and each of the first and second structural substances has a hydrophobic group.

23. The heat transport medium according to claim 1, which further contains one or more kinds of freezing-point depressants.

24. The heat transport medium according to claim 23, wherein the freezing-point depressant is a solid freezing-point depressant.

25. The heat transport medium according to claim 23, wherein the freezing-point depressant is a liquid freezing-point depressant.

26. The heat transport medium according to claim 23, which further contains at least one of a rust preventing agent and an antioxidant as an additive.
